(19) United States
(12) Patent Application Publication
(10) Pub. No.: US 2026/0214679 A1
(43) Pub. Date: Jul. 23, 2026

(54) BEAM COLLISION HANDLING FOR MULTIPLE-TRANSMISSION-AND-RECEPTION-POINT SYSTEMS

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Wenfeng LIU, Shenzhen (CN); Ling YANG, Shenzhen (CN)

(21) Appl. No.: 19/572,040

(22) Filed: Mar. 19, 2026

Related U.S. Application Data
(63) Continuation of application No. PCT/CN2023/122828, filed on Sep. 28, 2023.

(51) Int. Cl. H04W 72/232; H04W 72/1273

(52) U.S. Cl. CPC H04W 72/232; H04W 72/1273

(57) ABSTRACT

Systems, methods, and apparatus for wireless communication are described. A wireless communication method includes receiving, by a wireless device, a first indicated transmission configuration indicator (TCI) state specific to a first control resource set pool index and a second indicated TCI state specific to a second control resource set pool index. The method further includes receiving, by the wireless device, downlink control information (DCI) scheduling a physical downlink shared channel (PDSCH), where the DCI is associated with a control resource set pool index from the first and second control resource set pool indexes. The method further includes determining, by the wireless device and based on the DCI, a TCI state for the PDSCH.

### CROSS-REFERENCE TO RELATED APPLICATION

This application is a continuation and claims priority to International Application No. PCT/CN2023/122828, filed on Sep. 28, 2023, the disclosure of which is hereby incorporated by reference herein in its entirety.

### TECHNICAL FIELD

This patent document is directed generally to wireless communications.

### BACKGROUND

Mobile telecommunication technologies are moving the world toward an increasingly connected and networked society. In comparison with the existing wireless networks, next-generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data rates, large number of connections, ultra-low latency, high reliability, and other emerging business needs.

### SUMMARY

Techniques are disclosed for determining transmission configuration indicator (TCI) states for physical downlink shared channels (PDSCHs) and quasi co-location (QCL) properties for aperiodic channel state information reference signals (AP-CSI-RSs) in multiple-transmission-and-reception-point (MTRP) operations. The determination can be based on downlink control information (DCI) or downlink (DL) signals. The determination can be based on the types of the DL signals and whether the user equipment (UE) supports multiple default beams.

A first example wireless communication method includes receiving, by a wireless device, a first indicated transmission configuration indicator (TCI) state specific to a first control resource set pool index and a second indicated TCI state specific to a second control resource set pool index. The method further includes receiving, by the wireless device, downlink control information (DCI) scheduling a physical downlink shared channel (PDSCH), where the DCI is associated with a control resource set pool index from the first and second control resource set pool indexes. The method further includes determining, by the wireless device and based on the DCI, a TCI state for the PDSCH.

A second example wireless communication method includes receiving, by a wireless device, downlink control information (DCI) scheduling a physical downlink shared channel (PDSCH), where a scheduling offset between the PDSCH and the DCI is less than a threshold. The method further includes prioritizing, by the wireless device, a reception of a physical downlink control channel (PDCCH), where the PDCCH overlaps with the PDSCH in at least one time unit. The method further includes receiving, by the wireless device, the PDCCH.

A third example wireless communication method includes receiving, by a wireless device, a downlink (DL) signal. The method further includes receiving, by the wireless device, downlink control information (DCI) triggering an aperiodic channel state information reference signal (AP-CSI-RS), where a triggering offset between the AP-CSI-RS and the DCI is less than a threshold, and where the AP-CSI-RS overlaps with the DL signal in at least one time unit. The method further includes determining, by the wireless device and based on the DL signal, a quasi co-location (QCL) property for the AP-CSI-RS.

A fourth example wireless communication method includes transmitting, by a network node, a first indicated transmission configuration indicator (TCI) state specific to a first control resource set pool index and a second indicated TCI state specific to a second control resource set pool index. The method further includes transmitting, by the network node, downlink control information (DCI) scheduling a physical downlink shared channel (PDSCH), where the DCI is associated with a control resource set pool index from the first and second control resource set pool indexes. The method further includes transmitting, by the network node and based on the DCI, the PDSCH according to a TCI state.

A fifth example wireless communication method includes transmitting, by a network node, downlink control information (DCI) scheduling a physical downlink shared channel (PDSCH), where a scheduling offset between the PDSCH and the DCI is less than a threshold. The method further includes prioritizing, by the network node, a transmission of a physical downlink control channel (PDCCH), where the PDCCH overlaps with the PDSCH in at least one time unit. The method further includes transmitting, by the network node, the PDCCH.

A sixth example wireless communication method includes transmitting, by a network node, a downlink (DL) signal. The method further includes transmitting, by the network node, downlink control information (DCI) triggering an aperiodic channel state information reference signal (AP-CSI-RS), where a triggering offset between the AP-CSI-RS and the DCI is less than a threshold, and where the AP-CSI-RS overlaps with the DL signal in at least one time unit. The method further includes transmitting, by the network node and based on the DL signal, the AP-CSI-RS according to a quasi co-location (QCL) property.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary beam-based transmission.

FIG. 2 illustrates an exemplary multiple-transmission-and-reception-point (MTRP) operation.

FIG. 3 illustrates an exemplary method of transmission configuration indicator (TCI) state determination.

FIG. 4 illustrates an exemplary beam collision in a single-downlink-control-information-based (S-DCI-based) MTRP operation with a control resource set.

FIG. 5 illustrates an exemplary beam collision in a S-DCI-based MTRP operation with a downlink (DL) signal.

FIG. 6 illustrates an exemplary beam collision in a multiple-downlink-control-information-based (M-DCI-based) MTRP operation.

FIG. 7 is an exemplary flowchart for determining a TCI state.

FIG. 8 is an exemplary flowchart for prioritizing a physical downlink control channel (PDCCH).

FIG. 9 is an exemplary flowchart for determining a quasi co-location (QCL) property.

FIG. 10 is an exemplary flowchart for transmitting a physical downlink shared channel (PDSCH).

FIG. 11 is an exemplary flowchart for transmitting a PDCCH.

FIG. 12 is an exemplary flowchart for transmitting an aperiodic channel state information reference signal (AP-CSI-RS).

FIG. 13 illustrates an exemplary block diagram of a hardware platform that may be a part of a network node or a wireless device.

FIG. 14 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols.

### I. Introduction

In 5G new radio (NR), analog beam-forming is first introduced into mobile communication for guaranteeing the robustness of high frequency communications. For downlink (DL) transmission, quasi-co location (QCL) state (also, the QCL state is called transmission configuration indicator (TCI) state, or beam state) has been introduced for supporting beam indication for DL control channel, i.e., physical downlink control channel (PDCCH), DL data channel, i.e., physical downlink sharing channel (PDSCH), and channel-state-information reference signalling (CSI-RS). Similarly, for uplink (UL) transmission, spatial relation information (for the perspective of technical documents, the corresponding higher layer parameter is called spatialRelationInfo) has been introduced for supporting beam indication for UL control channel, i.e., physical uplink control channel (PUCCH), and sounding reference signal (SRS). Besides, beam indication for UL data channel, i.e., physical uplink shared channel (PUSCH), is achieved through mapping with one or more SRS resources, which are indicated by gNodeB (gNB), and ports of the UL data channel. That means that the beam configuration for UL data channel can be derived from the spatial relation information associated with SRS resources or ports accordingly. Then, a unified TCI framework is introduced, and based on that, a single TCI state can be applied to both or either of DL signalling (e.g., PDSCH, PDCCH, and/or CSI-RS) and UL signalling (e.g., PUSCH, PUCCH, and/or SRS) for determining the corresponding transmit/receive (Tx/Rx) beam(s).

After that, as a further evolution of unified TCI framework, the unified TCI framework can be extended to multiple-transmission-and-reception-point-based (MTRP-based) operation. In short, the first and second TCI state(s) corresponding to the first transmission-and-reception-point (TRP) and second TRP can be indicated/activated by downlink control information (DCI) and medium access control (MAC) control element (MAC-CE), and then the first and second TCI state(s) are applied to respective DL/UL channel/reference signals (RSs) corresponding to different TRPs.

Although unified TCI indication corresponding to respective TRPs can minimize the probabilities of beam collision due to individual TCI/spatial relation update for separate DL/UL channels/RSs, there are still beam collisions for DL channel/RS in the unified TCI framework for MTRP operation for the case: PDSCH/aperiodic CSI-RS (AP-CSI-RS) with scheduling/triggering offset<a threshold+other DL signals. In details, we need to handle the following issues, in order to improve the gNB scheduling flexibility even with the restriction for analog beam switching.
1) Considering that the collision rules are much relevant to user equipment (UE) behavior for other DL signals, we need to identify the categories of corresponding DL signals, i.e., Type-A: normal DL signals, e.g., periodic/semi-persistent CSI-RS (P/SP-CSI-RS), PDSCH with scheduling offset>a threshold; Type-B: AP-CSI-RS, e.g., AP-CSI-RS with scheduling offset>a threshold, and then the AP-CSI-RS is configured with repetition or not. For instance, if the AP-CIS-RS is configured with repetition=off, it is assumed that the UE do not need to change its Rx beam while gNB-side beam sweeping is initiated.
2) Then, we need to consider the different UE behaviors for achieving this functionality: e.g., the UE can receive the PDSCH/AP-CSI-RS with scheduling offset<a threshold with two default beams (i.e., indicated TCI states). For instance, if the UE can support two default beams (e.g., the UE supports the capability of two default beams for single DCI (S-DCI) based MTRP in frequency range 2 (FR2)), we may can consider that we do not need any additional rules when the AP-CSI-RS with scheduling offset<a threshold is collided with a PDSCH with two indicated TCI states, otherwise, only one type of TCI state (i.e., first TCI state) can be applied to the AP-CSI-RS reception.
3) Finally, the above-mentioned threshold, it may be relevant to PDSCH/CSI-RS specific or CSI-RS with repetition=on/off (that is, introduce a new threshold/threshold-combination or reuse the legacy threshold (as in NR Rel-15/16)). For a threshold of repetition=on, it implies that the UE may need to activate an idle-mode panel for the subsequent beam training.

As the expense of wide or ultra-wide spectrum resources, the considerable propagation loss induced by the extremely high frequency becomes a noticeable challenge. To solve this, antenna array and beam-forming training technologies using massive multiple input multiple output (MIMO), e.g., up to 1024 antenna elements for one node, have been adopted to achieve beam alignment and obtain sufficiently high antenna gain. To keep low implementation cost while still benefit from antenna array, analog phase shifters become very attractive for implementing mmWave beam-forming, which means that the number of controllable phases is finite and the constant modulus constraints are placed on these antenna elements. Given the pre-specified beam patterns, the variable-phase-shift-based beam-forming (BF) training targets to identify the best pattern for subsequent data transmission generally, in the one-TRP and one-panel case.

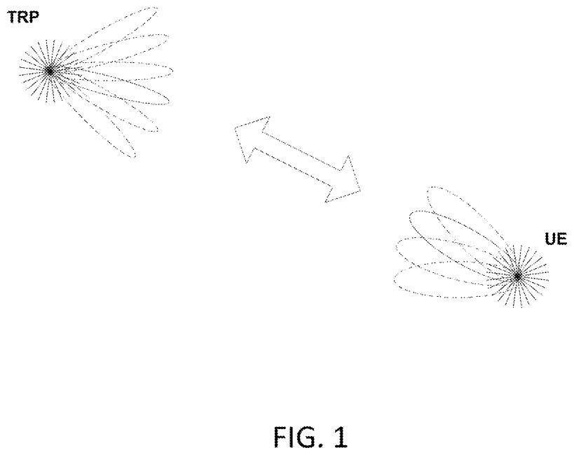

FIG. 1 shows a beam-based UL/DL transmission, where the full line represents the selected Tx/Rx beam for transmission.

Note that, in this patent document, the definition of “TCI state” is equivalent to quasi-co-location (QCL) state, transmission configuration indicator (TCI) state, spatial relation (also called spatial relation information), reference signal (RS), spatial filter or precoding. Furthermore, in this patent document, “TCI state” is also called “beam” or “beam state.” Furthermore, in this patent document, “TCI state” is equivalent to “indicated TCI state.” Furthermore, in this patent document, “TCI state” is equivalent to “joint/DL TCI state” or “TCI state” or “DL TCI state.”

Specifically,
a) The definition of “Tx beam” is equivalent to QCL state, TCI state, spatial relation state, DL reference signal, UL reference signal, Tx spatial filter or Tx precoding;
b) The definition of “Rx beam” is equivalent to QCL state, TCI state, spatial relation state, spatial filter, Rx spatial filter or Rx precoding;
c) The definition of “beam ID” is equivalent to QCL state index, TCI state index, spatial relation state index, reference signal index, spatial filter index or precoding index.

Specifically, the spatial filter can be either UE-side or gNB-side one, and the spatial filter is also called spatial-domain filter.

Note that, in this patent document, “spatial relation information” includes one or more reference RSs, which is used to represent the same or quasi-co “spatial relation” between targeted “RS or channel” and the one or more reference RSs.

Note that, in this patent document, “spatial relation” means the beam, spatial parameter, or spatial domain filter.

Note that, in this patent document, “TCI state” includes one or more reference RSs and their corresponding QCL type parameters, where QCL type parameters include at least one of the following aspect or combination: [1] Doppler spread, [2] Doppler shift, [3] delay spread, [4] average delay, [5] average gain, and [6] Spatial parameter (which is also called spatial Rx parameter). In this patent document, “TCI state” is equivalent to “QCL state”. In this patent document, there are the following definitions for “QCL-Type A,” “QCL-Type B,” “QCL-Type C,” and “QCL-Type D.”
“QCL-Type A”: {Doppler shift, Doppler spread, average delay, delay spread}
“QCL-Type B”: {Doppler shift, Doppler spread}
“QCL-Type C”: {Doppler shift, average delay}
“QCL-Type D”: {Spatial Rx parameter}

Note that, in this patent document, a RS includes channel state information reference signal (CSI-RS), synchronization signal block (SSB) (which is also called SS/physical broadcast channel (PBCH)), demodulation reference signal (DMRS), sounding reference signal (SRS), and physical random access channel (PRACH). Furthermore, the RS at least includes DL reference signal and UL reference signaling.

A DL RS at least includes CSI-RS, SSB, DMRS (e.g., DL DMRS);

A UL RS at least includes SRS, DMRS (e.g., UL DMRS), and PRACH.

Note that, in this patent document, “UL signal” can be PUCCH, PUSCH, or SRS.

Note that, in this patent document, “DL signal” can be PDCCH, PDSCH, or CSI-RS.

Note that, in this patent document, “time unit” can be sub-symbol, symbol, slot, subframe, frame, or transmission occasion.

Note that, in this patent document, CSI-RS for CSI is equivalent to CSI-RS configured without the higher layer parameters repetition and trs-Info.

Note that, in this patent document, CSI-RS for tracking is equivalent to CSI-RS configured with higher layer parameter trs-Info.

Note that, in this patent document, CSI-RS for beam management is equivalent to CSI-RS configured with higher layer parameter repetition.

Note that, in this patent document, PDCCH is equivalent to DCI, or DCI format.

Note that, in this patent document, a first TCI state is equivalent to a TCI state specific to coresetPoolIndex value 0. Furthermore, a first indicated TCI state is equivalent to an indicated TCI state specific to coresetPoolIndex value 0.

Note that, in this patent document, a second TCI state is equivalent to a TCI state specific to coresetPoolIndex value 1. Furthermore, a second indicated TCI state is equivalent to an indicated TCI state specific to coresetPoolIndex value 1.

Note that, in this patent document, “a device does not report its capability of supporting” is equivalent to “a device does not support.”

### II. Embodiment 1

Default TCI state determination for PDSCH and aperiodic CSI-RS with scheduling/triggering offset<a threshold.

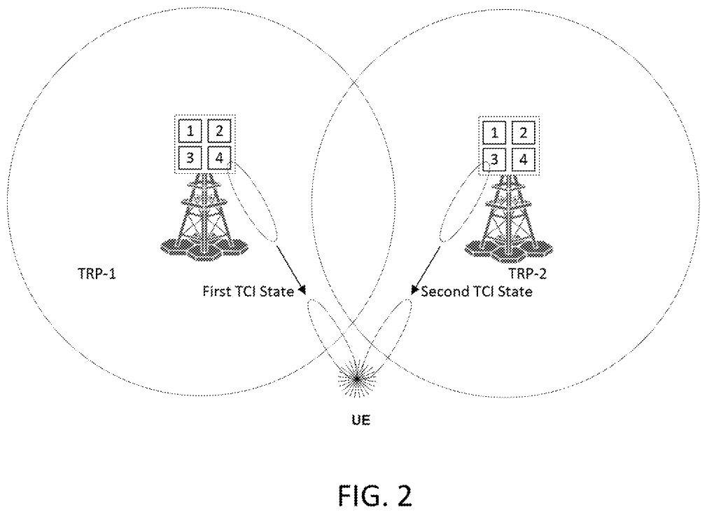

In the case of extension of unified TCI to MTRP operation, there are two indicated TCI state(s) rather than a single indicated TCI state as in single-transmission-and-reception-point (STRP) operation. FIG. 2 shows a unified TCI extension to MTRP operation using two indicated TCI states. As shown in FIG. 2, first and second TCI state(s) corresponding to TRP-1 and TRP-2, respectively, and then, for a given DL transmission, one or both of those first and second TCI states should be applied according to a specified rule.

In the following section, we first clarify the rule of determining the one or both of first and second TCI state(s) for a PDSCH with scheduling offset<a threshold or a CSI-RS with triggering offset<a threshold.

For PDSCH with scheduling offset<a threshold

For single DCI (S-DCI) based MTRP operation, that is, there are two indicated TCI states (there is no coresetPoolIndex associated with control resource set (CORESET)).

If the UE is in frequency range 1, or the UE reports its capability of two default beams (i.e., the UE can support two default beams) (e.g., for S-DCI based MTRP) in frequency range 2.

For PDSCH scheduling by DCI format 1_0, the UE should apply the first, second or both TCI state(s) according to RRC parameter (e.g., applyIndicatedTCIState). As in a default mode, if not configured, the first TCI states should be applied.

For PDSCH scheduling by DCI format 1_1/2, the UE should apply the first, second or both TCI state(s) according to TCI selection field in the DCI format 1_1/2. If the TCI selection field is not present in the DCI format, the UE should apply the both TCI state(s) in such case.

Otherwise (that is, the UE does not report its capability of two default beam(s), e.g., for S-DCI based MTRP), the UE should apply the first indicated TCI state (regardless of PDSCH scheduled by DCI format 0_0/1/2).

For multiple DCI (M-DCI) based MTRP operation, that is, there is a coresetPoolIndex associated with CORESET (e.g., there are two different values of coresetPoolIndex in different ControlResourceSets).

It is noted that, in principle, for PDSCH scheduled by a CORESET with a coresetPoolIndex, UE should apply the TCI state corresponding to the same coresetPoolIndex. But there may be some specific cases that should be clarified as follows.

If the UE is in frequency range 1, or the UE reports its capability of two default beams (i.e., the UE can support two default beams) (e.g., for M-DCI based MTRP) in frequency range 2.

Regardless of PDSCH scheduled by DCI format 0_0/1/2, for PDSCH scheduled by a PDCCH in a CORESET with a coresetPoolIndex, the UE should apply the TCI state corresponding to the same coresetPoolIndex.

Otherwise (that is, the UE does not report its capability of two default beam(s), e.g., for S-DCI based MTRP), the UE should apply the first indicated TCI state (regardless of PDSCH scheduled by DCI format 0_0/1/2).

The first indicated TCI state corresponds to an indicated TCI state specific to coresetPoolIndex value.

Furthermore, in such case, we have the at least one of the following additional requirements:
PDSCH with scheduled offset<a threshold can be scheduled by a PDCCH in a CORESET with a specific coresetPoolIndex (e.g., coresetPoolIndex=0);
The case that PDSCH with scheduled offset<a threshold is scheduled by a PDCCH in a CORESET with another specific coresetPoolIndex (e.g., coresetPoolIndex=1) is precluded.

Besides for PDSCH, we also need to have another rule for AP-CSI-RS with triggering offset<a threshold. It should be noted that, the thresholds for AP-CSI-RS and PDSCH may be the same or different, and some more details are discussed in the Embodiment #4.

Furthermore, if the offset between the reception of the scheduling/activation DCI format 1_0/1_1/1_2 and the scheduled or activated PDSCH reception is less than a threshold in frequency range 2, the UE shall apply the indicated TCI-State specific to coresetPoolIndex value 0 to the scheduled or activated PDSCH reception.

In such case, there is a coresetPoolIndex associated with a CORESET.

Furthermore, UE does not expect that the offset between the reception of the scheduling/activation DCI format 1_0/1_1/1_2 associated with coresetPoolIndex value 1 and the scheduled or activated PDSCH reception is less than a threshold in frequency range 2.

In such case, there is a coresetPoolIndex associated with a CORESET.

For AP-CSI-RS with triggering offset<a threshold.

For S-DCI based MTRP operation, that is, there are two indicated TCI states (there is no coresetPoolIndex associated with CORESET).

If the UE is in frequency range 1, or the UE reports its capability of two default beams (i.e., the UE can support two default beams) (e.g., for S-DCI based MTRP) in frequency range 2.

The UE shall apply the first or the second TCI state to the aperiodic CSI-RS according to the higher layer configuration(s) provided to the AP-CSI-RS resource or to the aperiodic CSI-RS resource set.

Otherwise (that is, the UE does not report its capability of two default beam(s), e.g., for S-DCI based MTRP), the UE shall apply the first TCI state to the AP-CSI-RS.

For M-DCI based MTRP operation, that is, there is a coresetPoolIndex associated with a control resource set (CORESET) (e.g., there are two different values of coresetPoolIndex in different CORESETs).

If the UE is in frequency range 1, or the UE reports its capability of two default beams (i.e., the UE can support two default beams) (e.g., for M-DCI based MTRP) in frequency range 2.

The UE shall apply the first or the second TCI state to the AP-CSI-RS according to the higher layer configuration(s) provided to the aperiodic CSI-RS resource or aperiodic CSI-RS resource set.

Otherwise (that is, the UE does not report its capability of two default beam(s), e.g., for S-DCI based MTRP), the UE should apply the indicated joint/DL TCI state corresponding to a specific coresetPoolIndex (e.g., coresetPoolIndex=0) to the aperiodic CSI-RS resource set.

If the QCL-Type D property in a slot for component carriers (CCs) in a band are different, the above TCI state(s) for the CC with lowest ID is prioritized, i.e., the default beam for the CC with lowest ID is applied to all the CCs in a band.

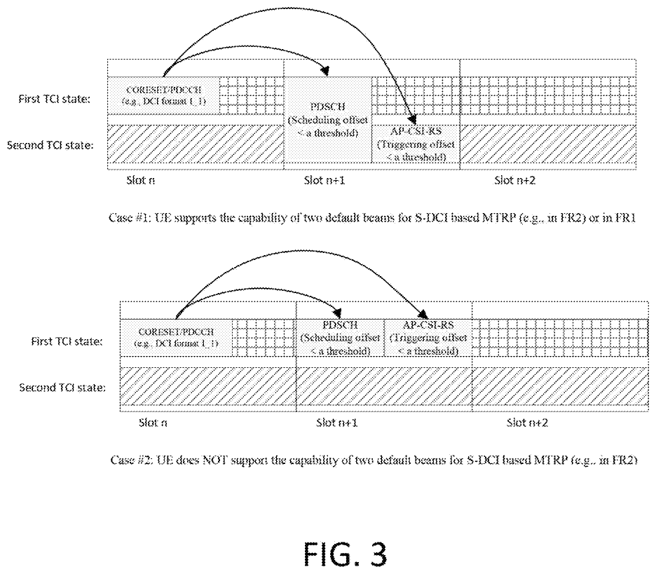

FIG. 3 illustrates determining one or both of first and second TCI state(s) (i.e., default beam rule) for PDSCH/CSI-RS with offset<a threshold. For instance, we have the following examples for S-DCI based MTRP as shown in FIG. 3, where we consider two typical cases: Case #1, UE supports the capability of two default beams for S-DCI based MTRP in FR2 or PDSCH/AP-CSI-RS transmission is in FR1; Case #2, UE does not support the capability of two default beams for S-DCI based MTRP in FR2, i.e., only one default beam. Based on above mentioned rule, we have the following analysis.

In Case #1, for a PDSCH scheduled by DCI format 1_1 where ‘TCI selection field’ in the DCI format 1_1 is to indicate both TCI state(s), the UE should use both the TCI states for subsequent PDSCH transmission with scheduling offset<a threshold; then, for AP-CSI-RS, following first or second TCI state is configured by a radio resource control (RRC) parameter, and if the AP-CSI-RS is configured with ‘following second TCI state’, the UE should apply the second TCI states to the AP-CSI-RS.

Then, in Case #2, for a PDSCH scheduled by DCI 1_1, regardless of indicated value of ‘TCI selection field’, the UE should use the first TCI state for PDSCH reception; then, for AP-CSI-RS, similarly, the UE should use the first TCI state for the AP-CSI-RS directly.

### III. Embodiment 2

Beam collision in S-DCI based MTRP.

In this embodiment, we elaborate beam collision rule for PDSCH/AP-CSI-RS with scheduling/triggering offset less than a threshold+other DL signals in S-DCI based MTRP operation (it should be noted that, “S-DCI based MTRP operation” is equivalent to the condition “there are two indicated TCI states” and/or “there is no coresetPoolIndex associated with CORESET”).

For PDSCH with scheduling offset less than a threshold, we consider the case of “the PDSCH with scheduling offset less than a threshold+CORESET/PDCCH,” i.e., other DL signal is CORESET/PDCCH.

If the PDSCH and PDCCH/CORESET is overlapped in at least one time unit (e.g., a symbol/OFDM-symbol), the reception of PDCCH is prioritized (over the PDSCH).

Furthermore, in such case, TCI state(s) corresponding to PDCCH/CORESET “is NOT in the scope of” or “is different from” the specific TCI state or “QCL-Type D” (i.e., QCL-Type D assumption for DL reception) of specific TCI state(s) (e.g., first or both TCI state(s) corresponding to the PDSCH) is different from that.

Furthermore, if the UE is in frequency range 1, or the UE reports its capability of two default beams (i.e., the UE can support two default beams) (e.g., for S-DCI based MTRP) in frequency range 2, the specific TCI states include both first and second TCI states.

Furthermore, “be different from” includes that the combination of TCI state/“QCL-Type D” (if greater than one) is different, or, for each of TCI state/“QCL-Type D,” there is no the same TCI state/“QCL-Type D.”

Furthermore, in such case, the UE does NOT report its capability of two default beams (i.e., the UE can NOT support two default beams) (e.g., for S-DCI based MTRP).

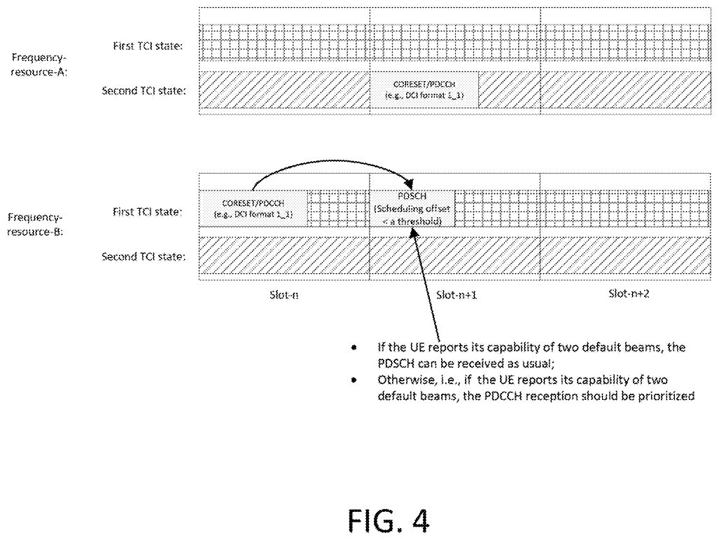

FIG. 4 illustrates beam collision of the PDSCH with scheduling offset<a threshold+CORESET/PDCCH in S-DCI based MTRP. For instance, we have the following examples as shown in FIG. 4, where there are two simultaneous transmission between CORESET/PDCCH and PDSCH with scheduling offset<a threshold in slot n+1. Based on above mentioned rule.

If the UE can report its capability of two default beams, it means that the specific TCI state(s) include both first and second TCI state(s), and then the TCI state corresponding to PDCCH/CORESET is not out of scope of the specific ones. Therefore, the PDSCH can be received well, and we do not need to specify any UE behaviour of prioritizing the CORESET/PDCCH in slot-n+2 transmission.

But, if the UE can NOT report its capability of two default beams, it means that the specific TCI state(s) corresponds to the first TCI state, and then the TCI state of CORESET/PDCCH (i.e., second TCI state) is different from the specific TCI state. Therefore, in such case, the PDCCH reception should be prioritized over the PDSCH.

Then, we further elaborate beam collision rule for AP-CSI-RS with scheduling/triggering offset less than a threshold+other DL signals in S-DCI based MTRP operation (it should be noted that, “S-DCI based MTRP operation” is equivalent to the condition “there are two indicated TCI states” and/or “there is no coresetPoolIndex associated with CORESET”).

When a UE is having two indicated TCI states, when the offset between the reception of the scheduling/activation DCI format 1_0/1_1/1_2 and the scheduled or activated PDSCH reception is less than a threshold, and if the PDSCH and a PDCCH overlaps in at least one symbol.

Furthermore, if the UE reports its capability of two default beams (i.e., two default beams for S-DCI based MTRP), and if the “QCL-Type D” s) corresponding to the PDCCH DMRS are different from either of two indicated joint/DL TCI states, the UE is expected to prioritize the reception of PDCCH.

Furthermore, if the UE does not report its capability of two default beams (i.e., two default beams for S-DCI based MTRP), and if the “QCL-Type D”s) corresponding to the PDSCH DMRS does NOT belong to those of PDCCH DMRS, the UE is expected to prioritize the reception of PDCCH.

When a UE is having two indicated TCI states, when the offset between the reception of the scheduling/activation DCI format 1_0/1_1/1_2 and the scheduled or activated PDSCH reception is less than a threshold, and if the PDSCH and a PDCCH overlaps in at least one symbol.

Furthermore, if the UE reports its capability of two default beams (i.e., two default beams for S-DCI based MTRP), and if the “QCL-Type D”s) corresponding to the PDCCH DMRS are not from two indicated joint/DL TCI states, the UE is expected to prioritize the reception of PDCCH.

Furthermore, if the UE does not report its capability of two default beams (i.e., two default beams for S-DCI based MTRP), and if the “QCL-Type D” corresponding to the PDSCH DMRS is different from any one of those of PDCCH DMRS, the UE is expected to prioritize the reception of PDCCH.

For AP-CSI-RS with triggering offset less than a threshold, we consider the case of ‘the AP-CSI-RS triggering offset+other DL signals’, where the DL signals can be divided into three categories: Type-1 DL signal applying both first and second TCI state(s) (e.g., PDSCH scheduled by DCI and applied both TCI states) and Type-2 DL signal applying either first or second TCI state (e.g., P/SP-CSI-RS with RRC configured ‘following first DL signal’), and Type-3 DL signal without following indicated TCI state(s) (i.e., either first or second TCI state) (e.g., individually configured with a TCI state rather than first or second TCI state) or applied indicated TCI state(s).

Furthermore, if the AP-CSI-RS and Type-1 DL signal applying both first and second TCI state(s) is overlapped in at least one time unit (e.g., a symbol/OFDM-symbol).

If the UE is in frequency range 1, or the UE reports its capability of two default beams (i.e., the UE can support two default beams) (e.g., for S-DCI based MTRP) in frequency range 2, the following UE behaviour (i.e., without collision) as mentioned in Embodiment #1 is used.

The UE shall apply the first or the second TCI state to the aperiodic CSI-RS according to the higher layer configuration(s) provided to the AP-CSI-RS resource or to the aperiodic CSI-RS resource set.

Otherwise (that is, the UE does not report its capability of two default beam(s), e.g., for S-DCI based MTRP), at least one of the following should be applied:
Option-1: The UE shall apply the first TCI state to the AP-CSI-RS (i.e., the same as the UE behaviour (i.e., no collision) as mentioned in Embodiment #1);
Option-2: The UE should apply the first or the second TCI state to the aperiodic CSI-RS according to the higher layer configuration(s) provided to the AP-CSI-RS resource or to the aperiodic CSI-RS resource set. It is considered that the UE has use both first and second TCI states for buffering the DL signals.

Furthermore, Type-1 DL signal includes a PDSCH with scheduling offset>=a threshold and applied both first and second TCI state(s), or a PDCCH in a CORESET (e.g., following both first and second TCI state).

Furthermore, if the AP-CSI-RS and Type-2 DL signal applying either first or second TCI state(s) is overlapped in at least one time unit (e.g., a symbol/OFDM-symbol), at least one of the following should be considered:
Option-1: the UE should apply the TCI state of Type-2 DL signal to the AP-CSI-RS;
Option-2: TCI state applying to the AP-CSI-RS is determined according to whether the UE is in FR1 or whether the UE reports its capability of two default beams.

Furthermore, if the UE is in frequency range 1, or the UE reports its capability of two default beams (i.e., the UE can support two default beams), the following UE behaviour (i.e., without collision) as mentioned in Embodiment #1 is used.

The UE shall apply the first or the second TCI state to the aperiodic CSI-RS according to the higher layer configuration(s) (e.g., RRC) provided to the AP-CSI-RS resource or to the aperiodic CSI-RS resource set.

Otherwise (i.e., that is, the UE does not report its capability of two default beam(s), e.g., for S-DCI based MTRP), the UE should apply the TCI state of Type-2 DL signal to the AP-CSI-RS.

Furthermore, the Type-2 DL signal at least includes PDSCH with scheduling offset>=a threshold, periodic CSI-RS (P-CSI-RS), semi-persistent CSI-RS (SP-CSI-RS), aperiodic CSI-RS with triggering offset>=a threshold, or a PDCCH in a CORESET (e.g., following indicated TCI state).

Furthermore, there may be two respective thresholds for different type of CSI-RS. For instance, a first type of threshold is used for CSI-RS for tracking, CSI-RS for CSI and/or CSI-RS for beam management (also with repetition=off); a second type of threshold is used for CSI-RS for beam management with repetition=on.

Furthermore, the first type of threshold is reported by the UE, and then the second type of threshold is a fixed one, e.g., 48 symbols.

Furthermore, the Type-2 DL signal at least includes a PDSCH with scheduling offset>=a threshold except for PDSCH having two indicated TCI state(s).

Furthermore, if the AP-CSI-RS and Type-3 DL signal without following indicated TCI state(s) (i.e., either first or second TCI state) is overlapped in at least one time unit (e.g., a symbol/OFDM-symbol), the UE should apply the TCI state of Type-3 DL signal to the AP-CSI-RS.

Furthermore, if the Type-3 DL signal have more than one TCI state/QCL assumption, the collision between AP-CSI-RS and Type-3 DL signal is precluded (i.e., the UE does not expect that the AP-CSI-RS is overlapped with Type-3 DL signal in at least one time unit).

Furthermore, the Type-3 DL signal at least includes periodic CSI-RS (P-CSI-RS), semi-persistent CSI-RS (SP-CSI-RS), aperiodic CSI-RS with triggering offset>=a threshold, or a PDCCH in a CORESET (e.g., not following indicated TCI state).

Furthermore, when a UE is having two indicated TCI states and if the offset between the last symbol of the PDCCH carrying the triggering DCI and the first symbol of the aperiodic CSI-RS resources in the aperiodic CSI-RS resource set is smaller than a threshold:
Furthermore, if there is a DL signal in the same symbols as the aperiodic CSI-RS in frequency range 2.

Furthermore, if the UE reports its capability of two default beams in frequency range 2, and if the DL signal is applied by either or both of the first and the second indicated joint/DL TCI states, the UE shall apply the first or the second indicated joint/DL TCI state to the aperiodic CSI-RS according to the higher layer configuration(s) provided to the aperiodic CSI-RS resource or to the aperiodic CSI-RS resource set.

Furthermore, otherwise, the UE shall apply the QCL assumption of the other DL signal to the aperiodic CSI-RS.

Furthermore, if there is NOT DL signal in the same symbols as the aperiodic CSI-RS in frequency range 2.

Furthermore, if the UE is in frequency range 1, or the UE reports its capability of two default beams in frequency range 2, the UE shall apply the first or the second indicated joint/DL TCI state to the aperiodic CSI-RS according to the higher layer configuration(s) provided to the aperiodic CSI-RS resource or to the aperiodic CSI-RS resource set.

Otherwise, the UE shall apply the first indicated joint/DL TCI state to the aperiodic CSI-RS.

Furthermore, the DL signal refers to PDSCH scheduled with an offset larger than or equal to a threshold, periodic CSI-RS, semi-persistent CSI-RS, and/or aperiodic CSI-RS scheduled with offset larger than or equal to a threshold.

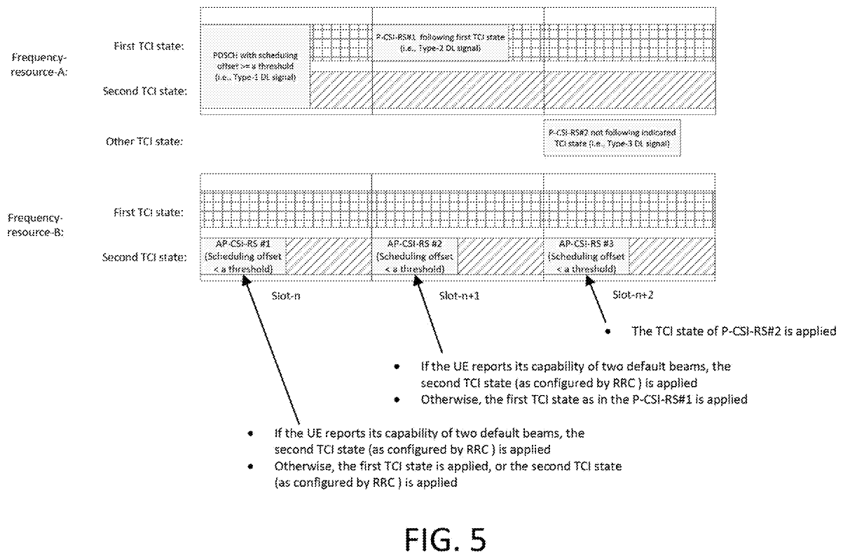

FIG. 5 illustrates beam collision of the AP-CSI-RS with scheduling offset<a threshold+other DL signals in S-DCI based MTRP operation. For instance, we have the following examples as shown in FIG. 5, where there are simultaneous transmissions between CSI-RS with scheduling offset<a threshold and other DL signals, which includes PDSCH with scheduling offset>=a threshold and both first and second TCI states in Slot-n (i.e., Type-1 DL signal), P-CSI-RS #1 following first TCI state (configured by RRC parameter) in Slot-n+1 (i.e., Type-2 DL signal) and P-CSI-RS #2 not following indicated TCI state (i.e., Type 3 DL signal). Based on above mentioned rule, we have the following.

When simultaneously transmitted with the PDSCH with scheduling offset>=a threshold in Slot-n, if the UE reports its capability of two default beams, the second TCI state (as configured by RRC) is applied to the AP-CSI-RS; Otherwise, we may have two options:
Option-1: the first TCI state is applied to the AP-CSI-RS, or Option-2, the second TCI state (as configured by RRC) is applied to the AP-CSI-RS.

When simultaneously transmitted with the P-CSI-RS #1 following first TCI state in Slot-n+1, if the UE reports its capability of two default beams, the second TCI state (as configured by RRC) is applied; Otherwise, the first TCI state is applied to the AP-CSI-RS.

When simultaneously transmitted with P-CSI-RS #2 not following indicated TCI state, the TCI state of P-CSI-RS #2 is applied to the AP-CSI-RS.

### IV. Embodiment 3

Beam collision in M-DCI based MTRP.

In this embodiment, we elaborate beam collision rule for PDSCH/AP-CSI-RS with scheduling/triggering offset less than a threshold+other DL signals in M-DCI based MTRP operation (it should be noted that, “M-DCI based MTRP operation” is equivalent to the condition “there is a coresetPoolIndex associated with a control resource set (CORESET) (e.g., there are two different values of coresetPoolIndex in different CORESETs)”).

For PDSCH with scheduling offset less than a threshold, we consider the case of “the PDSCH with scheduling offset+CORESET/PDCCH”, i.e., other DL signal is CORESET/PDCCH.

If the PDSCH and PDCCH/CORESET is overlapped in at least one time unit (e.g., a symbol/OFDM-symbol), and if a TCI state or “QCL-Type D” (i.e., QCL-Type D assumption for DL reception) of the TCI state of the PDSCH corresponding to a coresetPoolIndex is different from that of PDCCH/CORESET, the reception of PDCCH is prioritized (over the PDSCH).

Furthermore, PDCCH/CORESET is associated with the same coresetPoolIndex or same TCI state as the PDSCH.

Furthermore, PDCCH/CORESET is associated with the different coresetPoolIndex or different TCI state as the PDSCH.

Furthermore, the UE is in FR2.

Furthermore, the UE does not report its capability of two default beam(s), e.g., for M-DCI based MTRP.

For AP-CSI-RS with triggering offset less than a threshold, we consider the case of ‘the AP-CSI-RS triggering offset+other DL signals’, where the DL signals can be divided into three categories: Type-1 DL signal associated with the same TCI state (i.e., same first TCI state or same second TCI state) or same coresetPoolIndex as the AP-CSI-RS, Type-2 DL signal associated with the different type of TCI state or different coresetPoolIndex as the AP-CSI-RS, and Type-3 DL signal without following indicated TCI state(s) (i.e., either first or second TCI state) (e.g., individually configured with a TCI state rather than first or second TCI state).

Furthermore, if the AP-CSI-RS and Type-1 DL signal associated with the same TCI state (i.e., same first TCI state or same second TCI state) or same coresetPoolIndex as the AP-CSI-RS is overlapped in at least one time unit (e.g., a symbol/OFDM-symbol),

If the UE is in frequency range 1, or the UE reports its capability of two default beams (i.e., the UE can support two default beams) (e.g., for M-DCI based MTRP) in frequency range 2, the following UE behaviour (i.e., without collision) as mentioned in Embodiment #1 is used.

The UE shall apply the first or the second TCI state to the AP-CSI-RS according to the higher layer configuration(s) provided to the aperiodic CSI-RS resource or aperiodic CSI-RS resource set.

Otherwise (that is, the UE does not report its capability of two default beam(s), e.g., for M-DCI based MTRP), the UE shall apply the TCI state of Type-1 DL signal to the AP-CSI-RS or reuse the same UE behaviour as mentioned in Embodiment #1.

Furthermore, Type-1 DL signal at least includes PDSCH with scheduling offset >=a threshold, periodic CSI-RS (P-CSI-RS), semi-persistent CSI-RS (SP-CSI-RS), aperiodic CSI-RS with triggering offset>=a threshold, or a PDCCH in a CORESET (e.g., following indicated TCI state).

Furthermore, there may be two respective thresholds for different type of CSI-RS. For instance, a first type of threshold is used for CSI-RS for tracking, CSI-RS for CSI and/or CSI-RS for beam management (also with repetition=off); a second type of threshold is used for CSI-RS for beam management with repetition=on.

Furthermore, the first type of threshold is reported by the UE, and then the second type of threshold is a fixed one, e.g., 48 symbols.

Furthermore, if the AP-CSI-RS and Type-2 DL signal associated with the different type of TCI state or different coresetPoolIndex as the AP-CSI-RS is overlapped in at least one time unit (e.g., a symbol/OFDM-symbol), at least one of the following should be considered:
Option-1: the UE should apply the TCI state of Type-2 DL signal to the AP-CSI-RS;
Option-2: TCI state applying to the AP-CSI-RS is determined according to whether the UE is in FR1 or whether the UE reports its capability of two default beams.

Furthermore, if the UE is in frequency range 1, or the UE reports its capability of two default beams (i.e., the UE can support two default beams), the following UE behaviour (i.e., without collision) as mentioned in Embodiment #1 is used.

The UE shall apply the first or the second TCI state to the aperiodic CSI-RS according to the higher layer configuration(s) provided to the AP-CSI-RS resource or to the aperiodic CSI-RS resource set.

Otherwise (i.e., that is, the UE does not report its capability of two default beam(s), e.g., for M-DCI based MTRP), the UE should apply the TCI state of Type-2 DL signal to the AP-CSI-RS.

Furthermore, the Type-2 DL signal at least includes PDSCH with scheduling offset>=a threshold, periodic CSI-RS (P-CSI-RS), semi-persistent CSI-RS (SP-CSI-RS), aperiodic CSI-RS with triggering offset>=a threshold, or a PDCCH in a CORESET (e.g., following indicated TCI state).

Furthermore, there may be two respective thresholds for different type of CSI-RS. For instance, a first type of threshold is used for CSI-RS for tracking, CSI-RS for CSI and/or CSI-RS for beam management (also with repetition=off); a second type of threshold is used for CSI-RS for beam management with repetition=on.

Furthermore, the first type of threshold is reported by the UE, and then the second type of threshold is a fixed one, e.g., 48 symbols.

Furthermore, the Type-2 DL signal at least includes a PDSCH with scheduling offset>=a threshold except for PDSCH associated with the same TCI state as the AP-CSI-RS.

Furthermore, if the AP-CSI-RS and Type-3 DL signal without following indicated TCI state(s) (i.e., either first or second TCI state) is overlapped in at least one time unit (e.g., a symbol/OFDM-symbol), the UE should apply the TCI state of Type-3 DL signal to the AP-CSI-RS.

Furthermore, the Type-3 DL signal at least includes periodic CSI-RS (P-CSI-RS), semi-persistent CSI-RS (SP-CSI-RS), aperiodic CSI-RS with triggering offset>=a threshold, or a PDCCH in a CORESET (e.g., not following indicated TCI state).

In short, we may merge Type-1 and Type-2 DL signals together as Type-A DL signals (i.e., having first or second TCI state), and then we have the following rule:
Furthermore, if the AP-CSI-RS and Type A DL signal associated with first or second TCI state or different coresetPoolIndex as the AP-CSI-RS is overlapped in at least one time unit (e.g., a symbol/OFDM-symbol), at least one of the following should be considered:
Option-1: the UE should apply the TCI state of Type-A DL signal to the AP-CSI-RS;

Option-2: TCI state applying to the AP-CSI-RS is determined according to whether the UE is in FR1 or whether the UE reports its capability of two default beams.

Furthermore, if the UE is in frequency range 1, or the UE reports its capability of two default beams (i.e., the UE can support two default beams), the following UE behaviour (i.e., without collision) as mentioned in Embodiment #1 is used.

The UE shall apply the first or the second TCI state to the aperiodic CSI-RS according to the higher layer configuration(s) provided to the AP-CSI-RS resource or to the aperiodic CSI-RS resource set.

Otherwise (i.e., that is, the UE does not report its capability of two default beam(s), e.g., for M-DCI based MTRP), the UE should apply the TCI state of Type-A DL signal to the AP-CSI-RS.

Furthermore, the Type-A DL signal at least includes PDSCH with scheduling offset>=a threshold, periodic CSI-RS (P-CSI-RS), semi-persistent CSI-RS (SP-CSI-RS), aperiodic CSI-RS with triggering offset>=a threshold.

Furthermore, there may be two respective thresholds for different type of CSI-RS. For instance, a first type of threshold is used for CSI-RS for tracking, CSI-RS for CSI and/or CSI-RS for beam management (also with repetition=off); a second type of threshold is used for CSI-RS for beam management with repetition=on.

Furthermore, the first type of threshold is reported by the UE, and then the second type of threshold is a fixed one, e.g., 48 symbols.

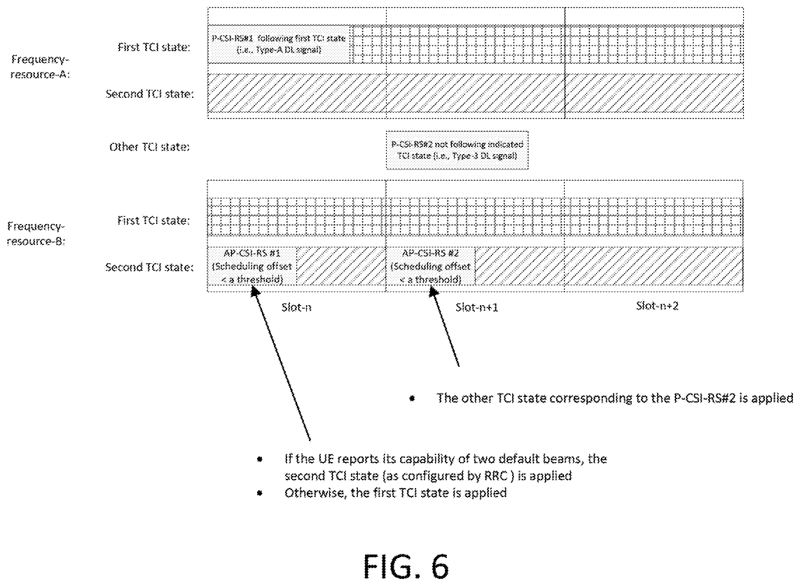

FIG. 6 illustrates beam collision of the AP-CSI-RS with scheduling offset<a threshold+other DL signals in M-DCI based MTRP operation. For instance, we have the following examples as shown in FIG. 6, where there are simultaneous transmissions between CSI-RS with scheduling offset<a threshold and other DL signals, which includes P-CSI-RS #1 following first TCI state (configured by RRC parameter) in Slot-n (i.e., Type-A DL signal or Type-2 DL signal) and P-CSI-RS #2 not following indicated TCI state (i.e., Type 3 DL signal). Based on above mentioned rule, we have the following.

When simultaneously transmitted with the P-CSI-RS #1 following first TCI state in Slot-n+1, if the UE reports its capability of two default beams, the second TCI state (as configured by RRC) is applied; Otherwise, the first TCI state is applied to the AP-CSI-RS.

When simultaneously transmitted with P-CSI-RS #2 not following indicated TCI state, the TCI state of P-CSI-RS #2 is applied to the AP-CSI-RS.

### V. Embodiment 4

UE capability report for PDSCH/CSI-RS related threshold.

In this embodiment, we focus on the UE capability report for PDSCH/CSI-RS related threshold. Then, we have the following two candidates:
Option-1: UE can indicate a common threshold for both PDSCH and CSI-RS.

For instance, the candidate value for the common threshold is {14, 28, 48}.

Option-2: UE can indicate separate threshold for PDSCH and CSI-RS.

Furthermore, UE can additionally indicate another threshold for CSI-RS (e.g., for CSI-RS for beam management with repetition=on).

The candidate value for another threshold can be {224, 336} which is used to enable an idle UE panel for further UE-side Rx beam sweeping.

Furthermore, another threshold is reported by the UE, and then threshold for CSI-RS for beam management with repetition=on (as a Type-II CSI-RS) is a fixed one, e.g., 48 symbols.

Furthermore, for report format in the corresponding UE capability signaling, for Option-1, the UE may indicate a combination of {common threshold, another threshold for CSI-RS}, e.g., {14, 224}.

In this patent document, we propose a comprehensive approach for handling beam collision for downlink channel and RS in the unified TCI framework for MTRP operation, in order to facilitate the NW scheduling flexibility even considering the latency of beam switching (i.e., corresponding to a threshold). Firstly, we provide the specified default beam/TCI state determination rules for PDSCH with scheduling offset<a threshold or AP-CSI-RS with triggering offset<a threshold; then, for S-DCI and M-DCI based MTRP operation, we separately provide the detailed rules if the above two DL channel/signal is transmitted simultaneously with other DL signals in a same time unit; finally, reporting of UE capability of a threshold for respective PDSCH and CSI-RS is analyzed in detail.

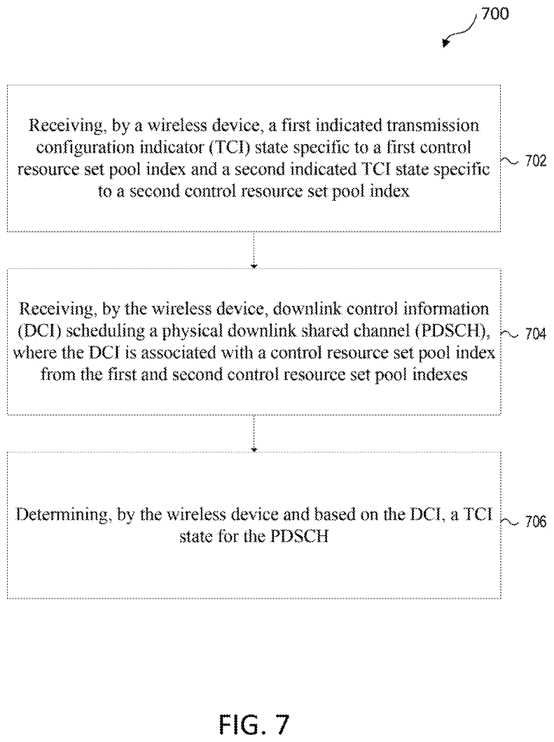

FIG. 7 is an exemplary flowchart for determining a TCI state. Operation 702 includes receiving, by a wireless device, a first indicated transmission configuration indicator (TCI) state specific to a first control resource set pool index and a second indicated TCI state specific to a second control resource set pool index. Operation 704 includes receiving, by the wireless device, downlink control information (DCI) scheduling a physical downlink shared channel (PDSCH), where the DCI is associated with a control resource set pool index from the first and second control resource set pool indexes. Operation 706 includes determining, by the wireless device and based on the DCI, a TCI state for the PDSCH. In some embodiments, the method can be implemented according to Embodiment 1. In some embodiments, performing further steps of the method can be based on a better system performance than a legacy protocol.

In some embodiments, a scheduling offset between the PDSCH and the DCI is less than a threshold. In some embodiments, where the wireless device is in frequency range 1, or the wireless device reports its capability of supporting more than one default beam in frequency range 2, determining the TCI state includes applying an indicated TCI state specific to the control resource set pool index associated with the DCI.

In some embodiments, where the wireless device is in frequency range 2, or the wireless device does not report its capability of supporting more than one default beam, at least one of the following applies: determining the TCI state includes applying the first indicated TCI state if the control resource set pool index associated with the DCI has a specific value (the specific value is “0”), or if the DCI is associated with the first control resource set pool index; or the PDSCH is not schedulable if the first control resource set pool index and the control resource set pool index associated with the DCI have different values.

In some embodiments, where a scheduling offset between the PDSCH and the DCI is greater than or equal to a threshold, at least one of the following applies: the DCI is associated with the second control resource set pool index (e.g., the second control resource set pool index has a value of “1”); the DCI is not associated with the first control resource set pool index (e.g., the first control resource set pool index has a value of “0”); or the control resource set pool index associated with the DCI has a specific value (e.g., the specific value is “1”).

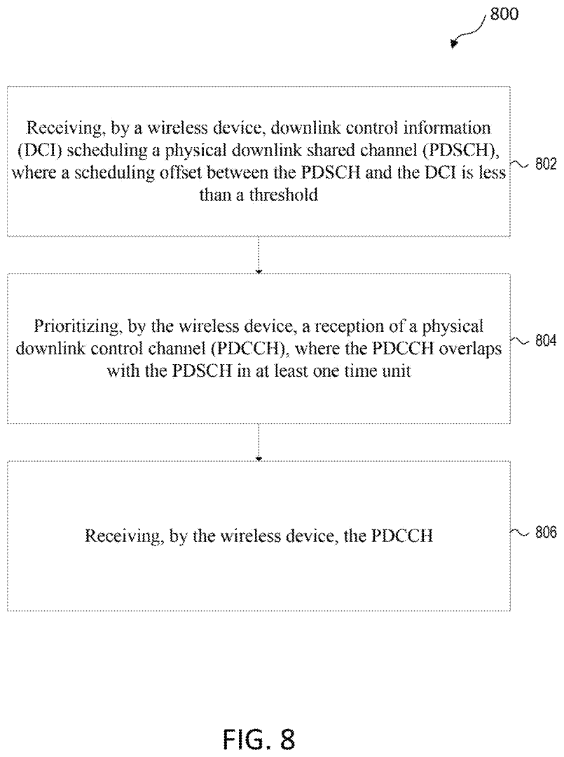

FIG. 8 is an exemplary flowchart for prioritizing a physical downlink control channel (PDCCH). Operation 802 includes receiving, by a wireless device, downlink control information (DCI) scheduling a physical downlink shared channel (PDSCH), where a scheduling offset between the PDSCH and the DCI is less than a threshold. Operation 804 includes prioritizing, by the wireless device, a reception of a physical downlink control channel (PDCCH), where the PDCCH overlaps with the PDSCH in at least one time unit. Operation 806 includes receiving, by the wireless device, the PDCCH. In some embodiments, the method can be implemented according to Embodiments 2 and 3. In some embodiments, performing further steps of the method can be based on a better system performance than a legacy protocol.

In some embodiments, the method further includes receiving, by the wireless device, a first indicated transmission configuration indicator (TCI) state and a second indicated TCI state, where one or more TCI states corresponding to the PDCCH are different from, are not from, do not belong to, or do not include one or more specific TCI states from the first and second indicated TCI states, where one or more TCI states corresponding to the PDCCH are different from any one of one or more specific TCI states from the first and second indicated TCI states, where quasi co-location type D (QCL-Type D) properties corresponding to the PDCCH are different from, are not from, do not belong to, or do not comprise one or more specific TCI states from the first and second indicated TCI states, or where QCL-Type D properties corresponding to the PDCCH are different from, are not from, do not belong to, or do not comprise QCL-Type D properties corresponding to one or more specific TCI states from the first and second indicated TCI states.

In some embodiments, where the wireless device is in frequency range 1, or the wireless device reports its capability of supporting more than one default beam in frequency range 2, the one or more specific TCI states include both the first indicated TCI state and the second indicated TCI state. In some embodiments, the one or more specific TCI states from the first and second indicated TCI states are applied to the PDSCH, or the wireless device is in frequency range 2, or the wireless device does not report its capability of supporting more than one default beam.

In some embodiments, quasi co-location type D (QCL-Type D) properties corresponding to the PDCCH are different from, are not from, do not belong to, or do not include QCL-Type D properties corresponding to the PDSCH, QCL-Type D properties corresponding to the PDCCH are different from any one of QCL-Type D properties corresponding to the PDSCH, or wherein QCL-Type D properties corresponding to the PDSCH are different from any one of QCL-Type D properties corresponding to the PDCCH.

In some embodiments, the PDCCH is associated with a control resource set pool index, and a transmission configuration indicator (TCI) state or a quasi co-location type D (QCL-Type D) property for the PDSCH is different from that for the PDCCH.

In some embodiments, a transmission configuration indicator (TCI) state for the PDCCH corresponds to a same control resource set pool index as the PDSCH. In some embodiments, a transmission configuration indicator (TCI) state for the PDCCH corresponds to a different control resource set pool index from the PDSCH. In some embodiments, the wireless device is in frequency range 2, or the wireless device does not report its capability of supporting more than one default beam.

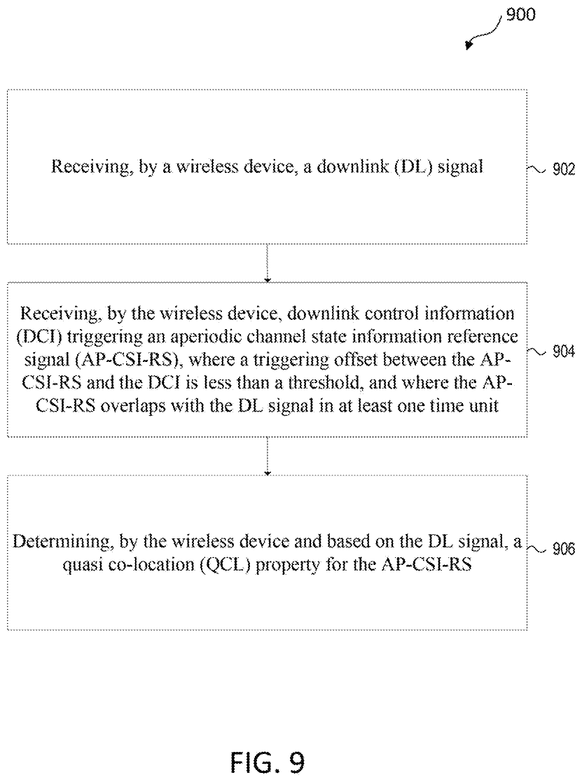

FIG. 9 is an exemplary flowchart for determining a quasi co-location (QCL) property. Operation 902 includes receiving, by a wireless device, a downlink (DL) signal. Operation 904 includes receiving, by the wireless device, downlink control information (DCI) triggering an aperiodic channel state information reference signal (AP-CSI-RS), where a triggering offset between the AP-CSI-RS and the DCI is less than a threshold, and where the AP-CSI-RS overlaps with the DL signal in at least one time unit. Operation 906 includes determining, by the wireless device and based on the DL signal, a quasi co-location (QCL) property for the AP-CSI-RS. In some embodiments, the method can be implemented according to Embodiments 2 and 3. In some embodiments, performing further steps of the method can be based on a better system performance than a legacy protocol.

In some embodiments, at least one of the following applies: one or more transmission configuration indicator (TCI) states corresponding to the DL signal are different from or do not include a specific TCI state indicated by a higher layer configuration provided to the AP-CSI-RS; one or more QCL properties corresponding to the DL signal are different from or do not include the QCL property for the AP-CSI-RS; or one or more TCI states corresponding to the DL signal are different from or do not include a TCI state corresponding to the AP-CSI-RS.

In some embodiments, at least one of the following applies: the DCI is associated with a control resource set pool index; or a control resource set pool index associated with the DL signal and a control resource set pool index associated with the AP-CSI-RS have different values.

In some embodiments, the method further includes receiving, by the wireless device, a first indicated transmission configuration indicator (TCI) state and a second indicated TCI state, where the DL signal includes one of a type-1 DL signal, type-2 DL signal, or a type-3 DL signal.

In some embodiments, the type-1 DL signal applies both the first indicated TCI state and the second indicated TCI state, the type-2 DL signal applies either the first indicated TCI state or the second indicated TCI state, and the type-3 DL signal does not apply or follow an indicated TCI state.

In some embodiments, the type-1 DL signal includes one or more of: a physical downlink shared channel (PDSCH), where a scheduling offset of the PDSCH is greater than or equal to a threshold; or a physical downlink control channel (PDCCH) in a control resource set.

In some embodiments, the type-2 DL signal includes one or more of: a physical downlink shared channel (PDSCH), where a scheduling offset of the PDSCH is greater than or equal to a first threshold; an additional PDSCH except if the additional PDSCH has two indicated TCI states; a periodic channel state information reference signal (P-CSI-RS); a semi-persistent channel state information reference signal (SP-CSI-RS); an additional AP-CSI-RS, where a triggering offset of the additional AP-CSI-RS is greater than or equal to a second threshold; or a physical downlink control channel (PDCCH) in a control resource set.

In some embodiments, the type-3 DL signal includes one or more of: a periodic channel state information reference signal (P-CSI-RS); a semi-persistent channel state information reference signal (SP-CSI-RS); an additional AP-CSI-RS, where a triggering offset of the additional AP-CSI-RS is greater than or equal to a threshold; or a physical downlink control channel (PDCCH) in a control resource set.

In some embodiments, where the DL signal includes the type-1 DL signal, where the wireless device is in frequency range 1, or the wireless device reports its capability of supporting more than one default beam in frequency range 2, determining the QCL property includes applying one of the first indicated TCI state or the second indicated TCI state according to a higher layer configuration provided to the AP-CSI-RS.

In some embodiments, where the DL signal includes the type-1 DL signal, where the wireless device is in frequency range 2, or the wireless device does not report its capability of supporting more than one default beam, at least one of the following applies:
determining the QCL property includes applying the first indicated TCI state; determining the QCL property includes applying a TCI state or a QCL property of the type-1 DL signal; or
determining the QCL property includes applying one of the first indicated TCI state or the second indicated TCI state according to a higher layer configuration provided to the AP-CSI-RS.

In some embodiments, where the DL signal includes the type-2 DL signal, at least one of the following applies: determining the QCL property includes applying a TCI state or a QCL property of the type-2 DL signal; or the QCL property is determined according to whether the wireless device is in frequency range 1, or whether the wireless device reports its capability of supporting more than one default beam.

In some embodiments, where the wireless device is in frequency range 1, or the wireless device reports its capability of supporting more than one default beam in frequency range 2, determining the QCL property includes applying one of the first indicated TCI state or the second indicated TCI state according to a higher layer configuration provided to the AP-CSI-RS.

In some embodiments, where the wireless device is in frequency range 2, or the wireless device does not report its capability of supporting more than one default beam, determining the QCL property includes applying a TCI state or a QCL property of the type-2 DL signal.

In some embodiments, where the DL signal includes the type-3 DL signal, determining the QCL property includes applying a TCI state or a QCL property of the type-3 DL signal.

In some embodiments, an overlapping of the AP-CSI-RS and the DL signal in the at least one time unit is precluded if the DL signal includes more than one TCI state or QCL property.

In some embodiments, where the scheduling offset between the PDSCH and the DCI is less than a first threshold, where the triggering offset between the AP-CSI-RS and the DCI is less than a second threshold, the wireless device indicates a common threshold for the first and second thresholds or the wireless device indicates different thresholds for the first and second thresholds. In some embodiments, the first threshold of the different thresholds is a value indicated by the wireless device, and the second threshold of the different thresholds is a fixed value or a value indicated by the wireless device.

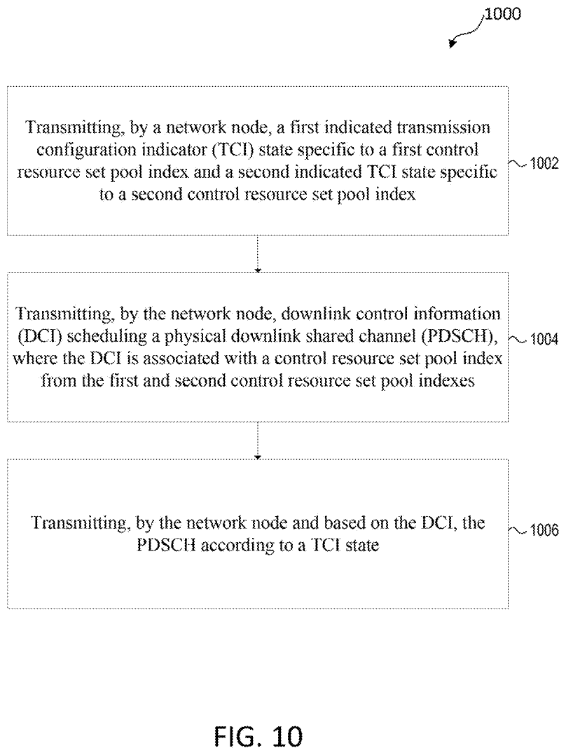

FIG. 10 is an exemplary flowchart for transmitting a PDSCH. Operation 1002 includes transmitting, by a network node, a first indicated transmission configuration indicator (TCI) state specific to a first control resource set pool index and a second indicated TCI state specific to a second control resource set pool index. Operation 1004 includes transmitting, by the network node, downlink control information (DCI) scheduling a physical downlink shared channel (PDSCH), where the DCI is associated with a control resource set pool index from the first and second control resource set pool indexes. Operation 1006 includes transmitting, by the network node and based on the DCI, the PDSCH according to a TCI state. In some embodiments, the method can be implemented according to Embodiment 1. In some embodiments, performing further steps of the method can be based on a better system performance than a legacy protocol.

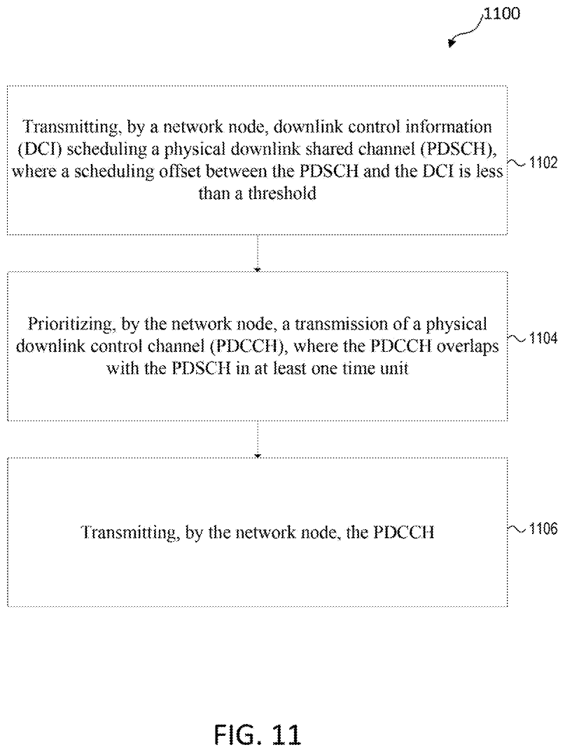

FIG. 11 is an exemplary flowchart for transmitting a PDCCH. Operation 1102 includes transmitting, by a network node, downlink control information (DCI) scheduling a physical downlink shared channel (PDSCH), where a scheduling offset between the PDSCH and the DCI is less than a threshold. Operation 1104 includes prioritizing, by the network node, a transmission of a physical downlink control channel (PDCCH), where the PDCCH overlaps with the PDSCH in at least one time unit. Operation 1106 includes transmitting, by the network node, the PDCCH. In some embodiments, the method can be implemented according to Embodiments 2 and 3. In some embodiments, performing further steps of the method can be based on a better system performance than a legacy protocol.

In some embodiments, the method further includes transmitting, by the network node and to a wireless device, a first indicated transmission configuration indicator (TCI) state and a second indicated TCI state, where one or more specific TCI states from the first and second indicated TCI states are applied to the PDSCH, and where one or more TCI states corresponding to the PDCCH are different from, are not from, do not belong to, or do not include the one or more specific TCI states.

In some embodiments, where the wireless device is in frequency range 1, or the wireless device reports its capability of supporting more than one default beam in frequency range 2, the one or more specific TCI states include both the first indicated TCI state and the second indicated TCI state.

In some embodiments, the wireless device is in frequency range 2, or the wireless device does not report its capability of supporting more than one default beam.

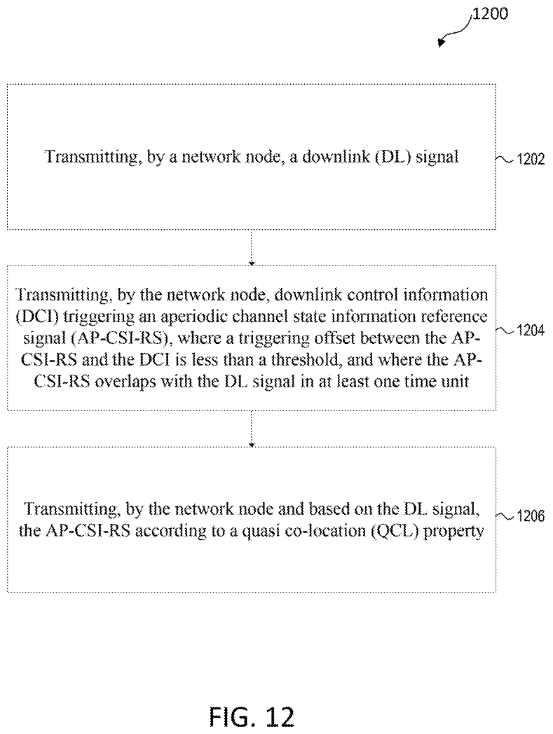

FIG. 12 is an exemplary flowchart for transmitting an AP-CSI-RS. Operation 1202 includes transmitting, by a network node, a downlink (DL) signal. Operation 1204 includes transmitting, by the network node, downlink control information (DCI) triggering an aperiodic channel state information reference signal (AP-CSI-RS), where a triggering offset between the AP-CSI-RS and the DCI is less than a threshold, and where the AP-CSI-RS overlaps with the DL signal in at least one time unit. Operation 1206 includes transmitting, by the network node and based on the DL signal, the AP-CSI-RS according to a quasi co-location (QCL) property. In some embodiments, the method can be implemented according to Embodiments 2 and 3. In some embodiments, performing further steps of the method can be based on a better system performance than a legacy protocol.

In some embodiments, the method further includes transmitting, by the network node and to a wireless device, a first indicated transmission configuration indicator (TCI) state and a second indicated TCI state, where the DL signal includes one of a type-1 DL signal, type-2 DL signal, or a type-3 DL signal.

In some embodiments, where the DL signal includes the type-1 DL signal, where the wireless device is in frequency range 1, or the wireless device reports its capability of supporting more than one default beam in frequency range 2, receiving the QCL property includes applying one of the first indicated TCI state or the second indicated TCI state according to a higher layer configuration provided to the AP-CSI-RS.

In some embodiments, where the DL signal includes the type-1 DL signal, where the wireless device is in frequency range 2, or the wireless device does not report its capability of supporting more than one default beam, at least one of the following applies: receiving the QCL property includes applying the first indicated TCI state; or receiving the QCL property includes applying one of the first indicated TCI state or the second indicated TCI state according to a higher layer configuration provided to the AP-CSI-RS.

In some embodiments, where the DL signal includes the type-2 DL signal, at least one of the following applies: receiving the QCL property includes applying a TCI state or a QCL property of the type-2 DL signal; or the QCL property is received according to whether the wireless device is in frequency range 1, or whether the wireless device reports its capability of supporting more than one default beam.

In some embodiments, where the DL signal includes the type-3 DL signal, receiving the QCL property includes applying a TCI state or a QCL property of the type-3 DL signal.

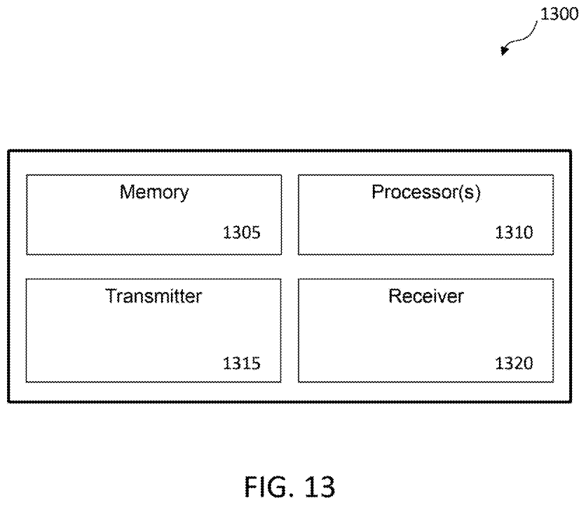

FIG. 13 shows an exemplary block diagram of a hardware platform 1300 that may be a part of a network node (e.g., base station, transmission parameter, or TRP) or a wireless device (e.g., a user equipment (UE)). The hardware platform 1300 includes at least one processor 1310 and a memory 1305 having instructions stored thereupon. The instructions upon execution by the processor 1310 configure the hardware platform 1300 to perform the operations described in FIGS. 1 to 12 and in the various embodiments described in this patent document. The transmitter 1315 transmits or sends information or data to another device. For example, a network node transmitter can send a message to a user equipment. The receiver 1320 receives information or data transmitted or sent by another device. For example, a user equipment can receive a message from a network note. For example, a UE or a network node, as described in the present document, may be implemented using the hardware platform 1300.

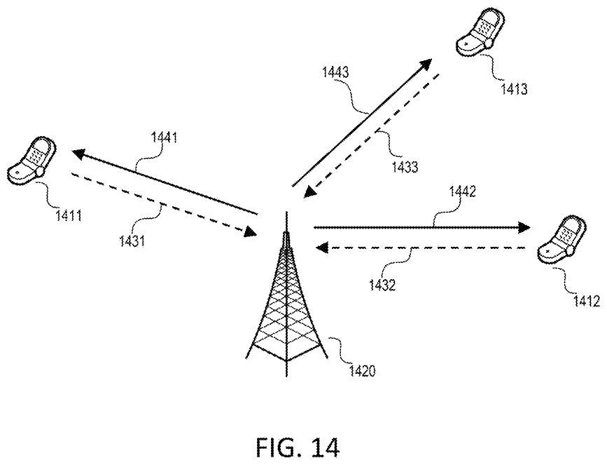

The implementations as discussed above will apply to a wireless communication. FIG. 14 shows an example of a wireless communication system (e.g., a 5G or NR cellular network) that includes a base station 1420 and one or more user equipment (UE) 1411, 1412 and 1413. In some embodiments, the UEs access the BS (e.g., the network, the TRP) using a communication link to the network (sometimes called uplink direction, as depicted by dashed arrows 1431, 1432, 1433), which then enables subsequent communication (e.g., shown in the direction from the network to the UEs, sometimes called downlink direction, shown by arrows 1441, 1442, 1443) from the BS to the UEs. In some embodiments, the BS send information to the UEs (sometimes called downlink direction, as depicted by arrows 1441, 1442, 1443), which then enables subsequent communication (e.g., shown in the direction from the UEs to the BS, sometimes called uplink direction, shown by dashed arrows 1431, 1432, 1433) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 1420 depicted in FIG. 14. The UEs can also communicate with BS for PDSCH, PDCCH, DCI, DL signal, CSI, CSI-RS, QCL property, or TCI state communications.

It will be appreciated by one of skill in the art that the present document discloses methods of determining TCI states for PDSCHs and QCL properties for AP-CSI-RSs. More specifically, the patent document discloses methods where wireless devices receive DCI or DL signals from different TRPs, obtain PDCCHs associated with specific control resource set pool indexes, and determine TCI states and QCL properties.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this patent document.

What is claimed is:

1. A method of wireless communication, comprising:
receiving, by a wireless device, a first indicated transmission configuration indicator (TCI) state associated with a first control resource set pool index having a value of 0 and a second indicated TCI state associated with a second control resource set pool index having a value of 1;
receiving, by the wireless device, a downlink control information (DCI) scheduling a physical downlink shared channel (PDSCH), wherein a scheduling offset between the PDSCH and the DCI is less than a threshold, and wherein the DCI is associated with either the first control resource set pool index or the second control resource set pool index; and
determining, by the wireless device and based on the DCI, a TCI state for the PDSCH.

2. The method of claim 1, wherein the wireless device does not report its capability of supporting more than one default beam, or the wireless device is in frequency range 2, and at least one of the following applies:
when the control resource set pool index associated with the DCI has the value of 0, or when the DCI is associated with the first control resource set pool index, the wireless device determines the TCI state by applying the first indicated TCI state.

3. The method of claim 1, wherein a scheduling offset between the PDSCH and the DCI is greater than or equal to a threshold, and wherein the DCI is associated with the second control resource set pool index.

4. A method of wireless communication, comprising:
receiving, by a wireless device, a downlink control information (DCI) scheduling a physical downlink shared channel (PDSCH), wherein a scheduling offset between the PDSCH and the DCI is less than a threshold;
prioritizing, by the wireless device, a reception of a physical downlink control channel (PDCCH), wherein the PDCCH overlaps with the PDSCH in at least one time unit; and
receiving, by the wireless device, the PDCCH.

5. The method of claim 4, wherein each quasi co-location type D (QCL-Type D) property corresponding to the PDSCH is different from each QCL-Type D property corresponding to the PDCCH.

6. The method of claim 5, wherein the wireless device does not report its capability of supporting more than one default beam, or the wireless device is in frequency range 2.

7. The method of claim 4, wherein the PDCCH is associated with a control resource set pool index, and wherein a transmission configuration indicator (TCI) state or a quasi co-location type D (QCL-Type D) property for the PDSCH is different from that for the PDCCH.

8. A method of wireless communication, comprising:
receiving, by a wireless device, a downlink (DL) signal;
receiving, by the wireless device, downlink control information (DCI) triggering an aperiodic channel state information reference signal (AP-CSI-RS), wherein a triggering offset between the AP-CSI-RS and the DCI is less than a threshold, and wherein the AP-CSI-RS overlaps with the DL signal in at least one time unit; and
determining, by the wireless device and based on the DL signal, a quasi co-location (QCL) property for the AP-CSI-RS.

9. The method of claim 8, wherein at least one transmission configuration indicator (TCI) state corresponding to the DL signal is different from a specific TCI state indicated by a higher layer configuration associated with the AP-CSI-RS.

10. The method of claim 8, further comprising:
receiving, by the wireless device, a first indicated transmission configuration indicator (TCI) state and a second indicated TCI state, wherein the DL signal comprises one of a type-1 DL signal or a type-2 DL signal, wherein the type-1 DL signal applies both the first indicated TCI state and the second indicated TCI state, and wherein the type-2 DL signal applies either the first indicated TCI state or the second indicated TCI state.

11. The method of claim 10, wherein the type-1 DL signal or the type-2 DL signal comprises a physical downlink shared channel (PDSCH), and wherein a scheduling offset of the PDSCH is greater than or equal to a threshold.

12. The method of claim 10, wherein the DL signal comprises the type-1 DL signal, wherein the wireless device is in frequency range 1, or the wireless device reports its capability of supporting more than one default beam in frequency range 2, and wherein determining the QCL property comprises applying the first indicated TCI state or the second indicated TCI state according to a higher layer configuration associated with the AP-CSI-RS.

13. The method of claim 10, wherein the DL signal comprises the type-1 DL signal, wherein the wireless device is in frequency range 2, and at least one of the following applies:
wherein determining the QCL property comprises applying the first indicated TCI state;
wherein determining the QCL property comprises applying a TCI state or a QCL property of the type-1 DL signal; or
wherein determining the QCL property comprises applying the first indicated TCI state or the second indicated TCI state according to a higher layer configuration associated with the AP-CSI-RS.

14. An apparatus for wireless communication, comprising at least one processor configured to cause the apparatus to implement the method recited in claim 1.

15. An apparatus for wireless communication, comprising at least one processor configured to cause the apparatus to implement the method recited in claim 4.

16. An apparatus for wireless communication, comprising at least one processor configured to cause the apparatus to implement the method recited in claim 8.
